(19) United States
(12) Patent Application Publication
(10) Pub. No.: US 2014/0141150 A1
(43) Pub. Date: May 22, 2014

(54) Mrs. Stallworth's 10 Minute Collard Greens Seasoning Mix

(71) Applicant: Carolyn Williams Stallowrth, Los Angeles, CA (US)

(72) Inventor: Carolyn Williams Stallowrth, Los Angeles, CA (US)

(21) Appl. No.: 14/034,308

(22) Filed: Sep. 23, 2013

Related U.S. Application Data
(60) Provisional application No. 61/703,919, filed on Sep. 21, 2012.

(51) Int. Cl. A23L 1/22

(52) U.S. Cl. CPC A23L 1/22
USPC 426/644

(57) ABSTRACT

The present invention provides method and ingredients to prepare collard greens in 10 minutes. First bring approximately three cups of water to a boil in a large pot. Then adds approximately one eighth cup of oil along with a package of seasoning mix. Next, the cook adds approximately two pounds or three bunches of cut collard greens to the boiling water. The cook stirs the greens continuously for approximately ten minutes and then places the cooked greens in a serving dish or bowl.

### CLAIM OF PRIORITY

This patent application claims priority under 35 USC 119 (e) (1) from U.S. Provisional Patent Application Ser. NO. 61/703,919 filed 09/21/2012 of common inventorship herewith entitled, “Mrs. Stallworth's 10 Minute Collard Greens Seasoning Mix.”

### FIELD OF THE INVENTION

The present invention pertains to the field of food spices, and more specifically to the field of seasoning mixes.

### BACKGROUND OF THE INVENTION

The prior art has put forth several designs for seasoning mixes. Among these are:

U.S. Pat. No. 6,558,691 to Teddy A. Koumarianos describes a food additive composition in a ground particulate composition containing multiple vitamins, calcium citrate, sugar, minerals, herbs, at least seventy to eighty percent by volume of different types of grains, ten to twenty percent by volume of beans, berries and cloves. Two different compositions containing dried vegetables and fruits are formulated, and the nutritious and flavorful additive compositions are added to food being cooked or while eating out.

US Patent 2006/0134300 to Arnold L. Newman describes an alertness inducing composition that contains the active ingredients caffeine and taurine and various inert substances in a dry formulation. Caffeine and taurine are delivered in an oral formulation that obviates the need for ingesting significant quantities of liquid or sugar. This nutritional supplement for mixing with a caffeine containing beverage is comprised of taurine and at least one ingredient selected from the group consisting of a sweetener, a vitaminic additive, a mineral additive, an amino acid additive, an herbal additive, bioactive nutrient additive, a creamer, proteins, glucuronolactone, a flavoring, and mixtures thereof, whereby, said nutritional supplement, when mixed with said caffeine-containing beverage, yields a functional energy drink.

U.S. Pat. No. 6,270,774 to Houn Simon Hsia and David Fan describes nutritional supplements to the human diet used to increase levels of high density lipoprotein or HDL and calcium ions, and decrease levels of free radicals and glucose in human blood plasma. More specifically, the present invention teaches novel nutritional supplements which comprise a novel combination of specific antioxidants, barley grass extract, specific multiple vitamins and minerals, and ginkgo biloba extract, as well as methods of preparing the nutritional supplements.

None of these prior art references describe the present invention.

### SUMMARY OF THE INVENTION

It is an object of the present invention to provide a novel and nutritional seasoning mix for collard greens.

### BRIEF DESCRIPTION OF THE DRAWINGS

FIG. 1 is a prototypical front diagonal view showing packaging design for a mild seasoning mix and a spicy seasoning mix.

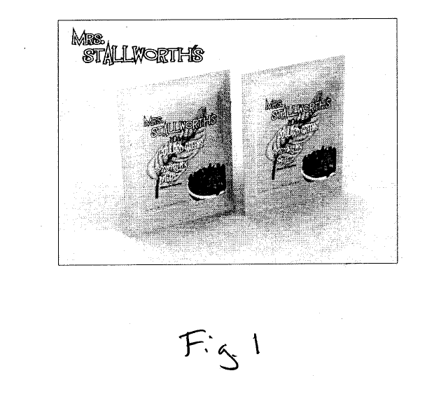

### DETAILED DESCRIPTION OF THE INVENTION

Collard greens date back to prehistoric times and are one of the oldest members of the cabbage family. With the arrival of African slaves to North America came a southern style of cooking collard greens. Like many other foods that originated at that time, this way of cooking was borne from the need to satisfy a slave family's hunger with bits of scrap that were thrown their way from the slave master's kitchen. Ham hocks, pig's feet and tops of greens were some of the things slaves turned into a tasty delicious meal. A tasty drinking juice left over from cooking collard greens is called pot likker. Nutritionally, collard greens are low in calories and contain no cholesterol. A good source of dietary fiber, collard greens are rich in sources of nutrients, antioxidant properties and folates. Collard greens are rich in Vitamin C, A, K, B complex, iron, calcium, copper, manganese, selenium and zinc. Chefs of many ethnicities have discovered the benefits of collard greens and added these greens to their cuisine, garnering interest from many people who were never exposed to them. Home cooks are increasingly buying greens in an attempt to combine flavor with the nutrition they know their family needs. Collard greens traditionally were boiled or slow simmered with salt pork or ham hock to soften up the leaves and make it less bitter. Presently, smoked turkey rings are often substituted in an effort to be more health conscious. Side dishes that accompany the greens include baked or fried corn bread, and some consumers like to put hot sauce on top of the greens for extra flavor. Although boiling is a preferred method of cooking greens, the unfortunate truth is that boiling leaches nutrients in its process.

The present invention, hereinafter referred to as Mrs. Stallworth's 10 Minute Collard Greens Seasoning Mix, is a spice mix added to collard greens to create a delicious nutritionally packed meal in ten minutes. The present invention's intent is to make this healthy vegetable more easily accessible to the mass public. Recognizing the need for a healthy vegetable meal mix that is prepared in minutes, Mrs. Stallworth's 10 Minute Collard Greens Seasoning Mix is certain to please both cooks and consumers. The Mix is available in both spicy and mild versions. Ingredients for the mild mix are:
SALT, SUGAR, CORN STARCH, MONOSODIUM GLUTMATE, BEEF FAT, HYDROLYZED CORN PROTEIN, DRIED CHICKEN MEAT, MALTODEXTRIN, AUTOLZED YEAST EXTRACT, CHICKEN FAT, SILCON DIOXIDE (PREVENTS CAKING) DEHYDRATED PARSLEY, DISCODIUM INOSINATE, CITRIC ACID, ONION POWDER, SODIUM BICARBONATE, COLORS, (YELLOW 5, ANNATTO YELLOW 6).

Ingredients for the spicy mix are:
SALT, SUGAR, CORN STARCH, MONSODIUM GLUTMATE, BEEF FAT, HYDROLYZED CORN PROTEIN, DRIED CHICKEN MEAT, MALTODEXTRIN, AUTOLZED YEAST EXTRACT, CHICKEN FAT, SILCON DIOXIDE (PREVENTS CAKING) DEHYDRATED PARSLEY, DISCODIUM INOSINATE, CITRIC ACID, ONION POWDER, NATURAL FLAVOR RED PEPPER, SODIUM BICARBONATE, COLORS, (YELLOW 5, ANNATTO YELLOW 6).

To prepare the collard greens with the present invention, the cook first brings approximately three cups of water to a boil in a large pot. Then the cook adds approximately one eighth cup of oil along with a package of seasoning mix. Next, the cook adds approximately two pounds or three bunches of cut collard greens to the boiling water. The cook stirs the greens continuously for approximately ten minutes and then places the cooked greens in a serving dish or bowl.

Collard greens traditionally are simmered for approximately forty five to fifty minutes which fades their vibrant green color and removes rich nutrients contained in raw collard greens. Potent antioxidant nutrients such as diindolylmethane and sulforophan also are removed, the dish is served devoid of its inherent nutritional quality, and its appearance is wilted and unappetizing. In contrast to this prior art technique, using the present invention reduces cooking time from approximately thirty five to fifty minutes to approximately ten minutes. A more visually appealing collard green which possesses more nutritional value is easily incorporated into many dishes. Children are easily cajoled into enjoying a serving of collard greens in various appetizing recipes such as a topping on pizzas, tacos, hamburgers or stuffed shrimp. Mrs. Stallworth's 10 Minute Collard Greens Seasoning Mix provides a combination of affordability, ease and nutritional value. The ability to produce a delicious nutritious side dish in ten minutes will receive an extremely enthusiastic market reception.

Although this invention has been described with respect to specific embodiments, it is not intended to be limited thereto and various modifications which will become apparent to the person of ordinary skill in the at are intended to fall within the spirit and scope of the invention as described herein taken in conjunction with the accompanying drawings and the appended claims.

1. A nutritional mild seasoning mix for collard greens, comprising: three cups of water, one eighth cup of oil, two pounds of collard greens, mix comprising: SALT, SUGAR, CORN STARCH, MONOSODIUM GLUTMATE, BEEF FAT, HYDROLYZED CORN PROTEIN, DRIED CHICKEN MEAT, MALTODEXTRIN, AUTOLZED YEAST EXTRACT, CHICKEN FAT, SILCON DIOXIDE (PREVENTS CAKING) DEHYDRATED PARSLEY, DISCODIUM INOSINATE, CITRIC ACID, ONION POWDER, SODIUM BICARBONATE, COLORS, (YELLOW 5, ANNATTO YELLOW 6).

2. A nutritional spicy seasoning mix for collard greens, comprising: three cups of water, one eighth cup of oil, two pounds of collard greens, mix comprising: SALT, SUGAR, CORN STARCH, MONSODIUM GLUTMATE, BEEF FAT, HYDROLYZED CORN PROTEIN, DRIED CHICKEN MEAT, MALTODEXTRIN, AUTOLZED YEAST EXTRACT, CHICKEN FAT, SILCON DIOXIDE (PREVENTS CAKING) DEHYDRATED PARSLEY, DISCODIUM INOSINATE, CITRIC ACID, ONION POWDER, NATURAL FLAVOR RED PEPPER, SODIUM BICARBONATE, COLORS, (YELLOW 5, ANNATTO YELLOW 6).

3. A method of making collard greens comprising:
combining in a large pot two pounds of collard greens, three cups of water, one-eighth cup oil, seasoning mix.

4. The method of claim 3, wherein the seasoning mix comprises: SALT, SUGAR, CORN STARCH, MONOSODIUM GLUTMATE, BEEF FAT, HYDROLYZED CORN PROTEIN, DRIED CHICKEN MEAT, MALTODEXTRIN, AUTOLZED YEAST EXTRACT, CHICKEN FAT, SILCON DIOXIDE (PREVENTS CAKING) DEHYDRATED PARSLEY, DISCODIUM INOSINATE, CITRIC ACID, ONION POWDER, SODIUM BICARBONATE, COLORS, (YELLOW 5, ANNATTO YELLOW 6).

5. The method of claim 3, wherein the seasoning mix comprises: SALT, SUGAR, CORN STARCH, MONSODIUM GLUTMATE, BEEF FAT, HYDROLYZED CORN PROTEIN, DRIED CHICKEN MEAT, MALTODEXTRIN, AUTOLZED YEAST EXTRACT, CHICKEN FAT, SILCON DIOXIDE (PREVENTS CAKING) DEHYDRATED PARSLEY, DISCODIUM INOSINATE, CITRIC ACID, ONION POWDER, NATURAL FLAVOR RED PEPPER, SODIUM BICARBONATE, COLORS, (YELLOW 5, ANNATTO YELLOW 6).
